(19) United States
(12) Patent Application Publication
(10) Pub. No.: US 2014/0068216 A1
(43) Pub. Date: Mar. 6, 2014

(54) STORAGE SYSTEM FOR SUPPORTING COPY COMMAND AND MOVE COMMAND AND OPERATION METHOD OF STORAGE SYSTEM

(71) Applicant: Hyun Mo Chung, Gyeonggi-do (KR)

(72) Inventor: Hyun Mo Chung, Gyeonggi-do (KR)

(73) Assignee: INDLINX CO LTD, GYEONGGI-DO (KR)

(21) Appl. No.: 14/003,318

(22) PCT Filed: Mar. 8, 2012
(86) PCT No.: PCT/KR12/01709

§ 371 Date: Nov. 18, 2013

(30) Foreign Application Priority Data
Mar. 9, 2011 (KR) 10-2011-0020817

(51) Int. Cl. G06F 3/06

(52) U.S. Cl. CPC G06F 3/065; G06F 3/0619; G06F 3/0673
USPC 711/162

(57) ABSTRACT

Provided are a storage system for supporting a copy command and a move command and an operation method of said storage system. The storage system performs a copy operation and a move operation without movement of data between a host and a storage device, by using a copy command and a move command which are distinguished from a read command and a write command. More specifically, the storage device updates a mapping table by responding to the reception of the copy command or the move command from the host.

### TECHNICAL FIELD

The present invention relates to an operation method of a storage system including a host and a storage device.

### BACKGROUND ART

A storage space provided by a storage device generally includes a plurality of logical blocks, and a size of each block is uniform. A host transmits, to the storage device, a preset command for reading or writing data to/from an arbitrary block. The storage device performs a read or write operation according to the command from the host.

According to circumstances, there is a need to replicate data present in an arbitrary logical block by copying the corresponding data to another logical block or to change a logical address of the data. For example, there is a case of backing up an arbitrary file (that is, data replication) by copying the corresponding file from an original partition to another partition, or a case of changing a logical address of the file during disc defragmentation.

In this instance, the host fetches data from the storage device through a read command and stores the data in another logical block of the storage device through a write command When the host uses a read command and a write command to perform a copy function, data should be transmitted from the storage device to the host and from the host to the storage device again, so that a processing time is long.

### DISCLOSURE OF INVENTION

### Technical Goals

An aspect of the present invention provides a method that simplifies a process of moving arbitrary data from one logical address to another, by additionally supporting a copy command and a move command as well as a read command and a write command generally supported by a storage system.

### Technical Solutions

According to an aspect of the present invention, there is provided an operation method of a storage device connected to a host, the operation method including maintaining a set of commands including a write command, a read command, and a copy command, receiving, from the host, a copy command for copying a target data indicated by an original logical address to a target logical address, and processing the copy command by updating a mapping table between a logical address and a physical address to enable both the original logical address and the target logical address to indicate the target data.

The processing of the copy command may include updating the mapping table to enable both the original logical address and the target logical address to indicate the target data while maintaining a physical address of a storage space in which the target data is stored.

The processing of the copy command may include extracting the target data from a first storage space in which the target data is stored, storing the target data in a second storage space, and updating the mapping table to enable the original logical address to indicate the target data stored in the first storage space and the target logical address to indicate the target data stored in the second storage space.

The storing of the target data in the second storage space may include storing the target data in the second storage space without returning the extracted target data to the host.

According to another aspect of the present invention, there is provided an operation method of a storage device connected to a host, the operation method including maintaining a set of commands including a write command, a read command, and a move command, receiving, from the host, a move command for moving a target data indicated by an original logical address to a target logical address, and processing the move command by updating a mapping table between a logical address and a physical address to enable the target logical address rather than the original logical address to indicate the target data.

The processing of the move command may include updating the mapping table to enable the target logical address rather than the original logical address to indicate the target data while maintaining a physical address of a storage space in which the target data is stored.

The processing of the move command may include extracting the target data from a first storage space in which the target data is stored, storing the target data in a second storage space, and invalidating the original logical address indicating the target data stored in the first storage space, and updating the mapping table to enable the target logical address to indicate the target data stored in the second storage space.

According to still another aspect of the present invention, there is provided a storage device connected to a host, the storage device including a memory array including a plurality of storage spaces, and a controller to process an arbitrary command among a set of commands including a write command, a read command, and a copy command, and the controller may process a copy command by updating a mapping table between a logical address and a physical address to enable both an original logical address and a target logical address to indicate a target data, when the copy command for copying the target data indicated by the original logical address to the target logical address is received from the host.

The controller may update the mapping table to enable both the original logical address and the target logical address to indicate the target data while maintaining a physical address of a storage space in which the target data is stored.

The controller may extract the target data from a first storage space in which the target data is stored, store the target data in a second storage space, and update the mapping table to enable the original logical address to indicate the target data stored in the first storage space and the target logical address to indicate the target data stored in the second storage space.

The set of commands may further include a move command, and the controller may process the move command by updating the mapping table to enable the target logical address rather than the original logical address to indicate the target data, when the move command for moving the target data indicated by the original local address to the target logical address is received from the host.

The controller may update the mapping table, in response to the move command, to enable the target logical address rather than the original logical address to indicate the target data while maintaining a physical address of a storage space in which the target data is stored.

The controller may extract, in response to the move command, the target data from a first storage space in which the target data is stored, store the target data in a second storage space, invalidate the original logical address indicating the target data stored in the first storage space, and update the mapping table to enable the target logical address to indicate the target data stored in the second storage space.

According to further another aspect of the present invention, there is provided a storage system including a host to transmit an arbitrary command among a set of commands including a write command, a read command, and a copy command, and a storage device including a memory array including a plurality of storage spaces and a controller to process the arbitrary command received from the host, and the controller may process a copy command by updating a mapping table between a logical address and a physical address to enable both an original logical address and a target logical address to indicate a target data, when the host transmits the copy command for copying the target data indicated by the original logical address to the target logical address.

### Effects of the Invention

A storage system according to an exemplary embodiment of the present invention may improve performance of the storage system, reduce the power consumption, and decrease the probability of data damage, by performing a copy operation and a move operation without moving data between a host and a storage device using a copy command and a move command distinguished from a read command and a write command.

### BRIEF DESCRIPTION OF DRAWINGS

FIG. 1 is a diagram illustrating an operation method of a storage system according to a related art.

FIG. 2 is a diagram illustrating a storage system using a copy command and a move command according to an exemplary embodiment of the present invention.

FIG. 3 is a diagram illustrating an example of processing a copy command in a storage device according to an exemplary embodiment of the present invention.

FIG. 4 is a diagram illustrating another example of processing a copy command in a storage device according to an exemplary embodiment of the present invention.

FIG. 5 is a flowchart illustrating an operation method of a storage device for processing a copy command and a move command according to an exemplary embodiment of the present invention.

### BEST MODE FOR CARRYING OUT THE INVENTION

Hereinafter, exemplary embodiments of the present invention are described in detail with reference to the accompanying drawings.

In the description of the exemplary embodiments of the present invention, descriptions of well-known functions or components are omitted so as to not unnecessarily obscure the embodiments herein. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein. Hence, the terms must be interpreted based on the contents of the entire specification.

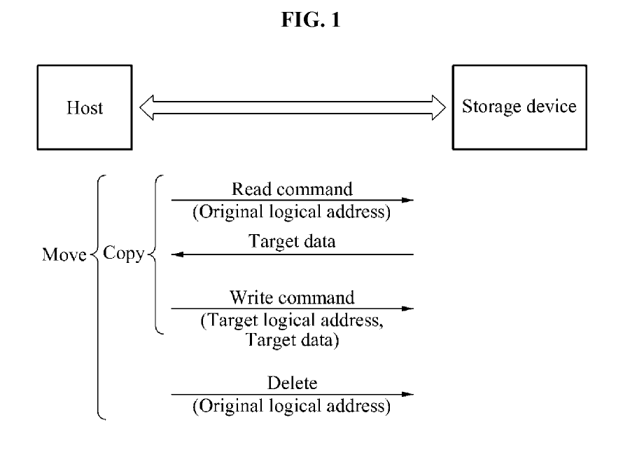

FIG. 1 is a diagram illustrating an operation method of a storage system according to a related art.

Referring to FIG. 1, for copying and movement of data, a conventional storage system including a host and a storage device operates as follows.

First, the host transmits a read command including an original logical address to the storage device. In response to the read command, the storage device transmits target data indicated by the original logical address to the host. The host transmits a write command including a target logical address and the target data to the storage device. Also, the storage device stores the target data in a storage space corresponding to the target logical address.

Accordingly, a process of copying the target data indicated by the original logical address to the target logical address is completed.

A move process further includes an operation of invalidating the original logical address in addition to the process of processing the copy command.

That is, in the conventional storage system, a process of copying or moving data using a read command and a write command includes transmitting data from the storage device to the host and from the host to the storage. As a result, iterative data transmission between the host and the storage device increases a processing time.

Accordingly, exemplary embodiments of the present invention additionally define a copy command and a move command of a simpler method as well as a read command and a write command supported by the conventional storage system, to omit a process of transmitting data from the storage device to the host and vice versa. Through this, a process of copying and moving arbitrary data may be simplified.

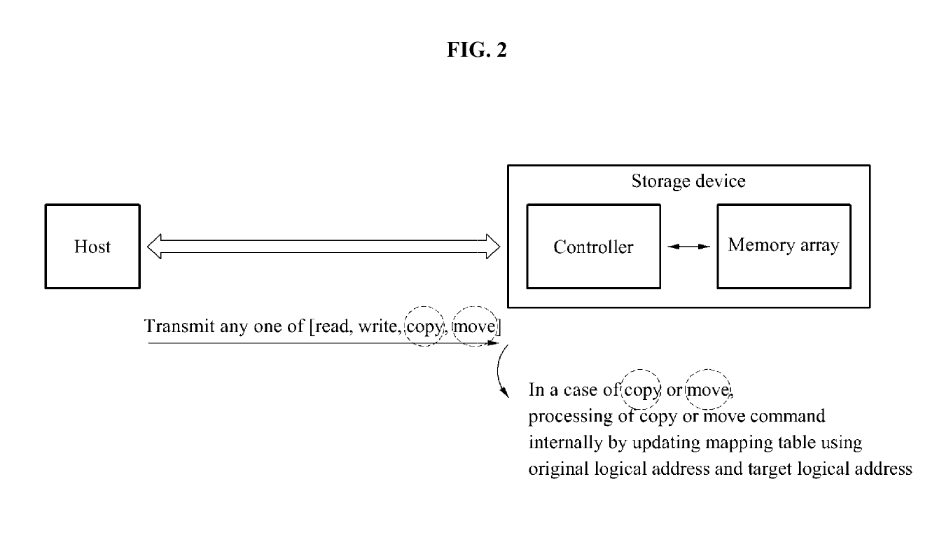

FIG. 2 is a diagram illustrating a storage system using a copy command and a move command according to an exemplary embodiment of the present invention.

Referring to FIG. 2, a storage system according to an exemplary embodiment of the present invention includes a host and a storage device.

The host transmits, to the storage device, an arbitrary command among a set of commands including a copy command and a move command as well as a write command and a read command. The copy command and the move command may include information associated with an original logical address and a target logical address. The original logical address represents a logical address indicating a storage space in which target data to be copied or moved is currently stored, and the target logical address represents a logical address indicating a storage space in which the target data is copied or moved and then is to be stored.

The storage device includes a controller and a memory array. The controller processes the arbitrary command received from the host, and the memory array includes a plurality of storage spaces to store data. The storage device may correspond to a solid state disk (SSD), and in this case, the memory array may correspond to a flash memory array. Also, the storage device may include various storage devices as well as an SSD.

For a copy command, operation of the storage system is as follows.

The host transmits, to the storage device, a copy command for copying the target data indicated by the original logical address to the target logical address. In response to the copy command, the controller updates a mapping table between a logical address and a physical address to enable both the original logical address and the target logical address to indicate the target data.

The mapping table represents a mapping relationship between the logical address recognized by the host and the physical address of the storage space of the memory array in which the data is stored.

A method of updating the mapping table by the controller for processing the copy command is classified largely into two methods.

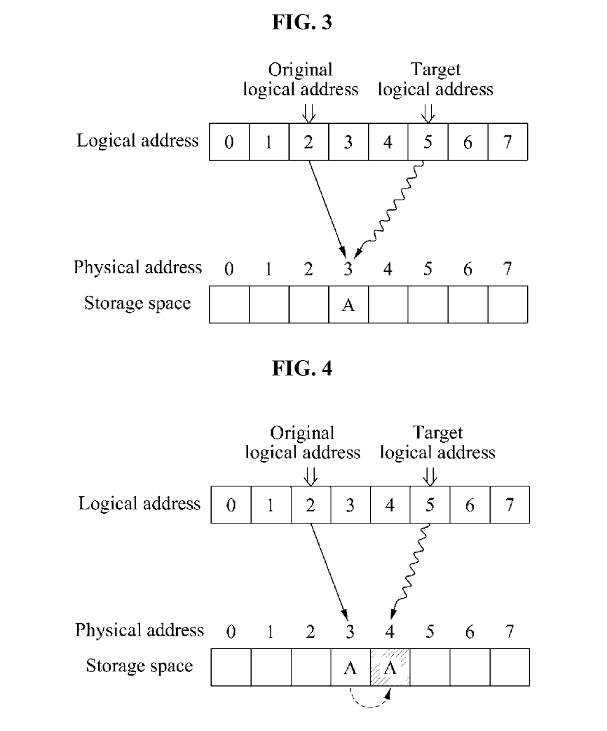

According to a first method, the controller may update the mapping table to enable both the original logical address and the target logical address to indicate the target data while maintaining the physical address of the storage space in which the target data is stored. In this case, the copy command may be only processed by modification of the mapping table without an operation of reading or transmitting the target data. Accordingly, a processing rate and data stability may be improved. A description of a specific example is provided with reference to FIG. 3.

According to a second method, the controller extracts the target data from a first storage space in which the target data is stored, and stores the target data in a second storage space. Also, the controller may update the mapping table to enable the original logical address to indicate the target data stored in the first storage space and the target logical address to indicate the target data stored in the second storage space. A description of a specific example is provided with reference to FIG. 4.

A common feature of the two methods of processing the copy command described in the foregoing is that the target data is not transmitted between the storage device and the host during processing the copy command. That is, in an exemplary embodiment of the present invention, if the host notifies only the original logical address and the target logical address to the storage device, the storage device alone may copy, to the target logical address, the target data corresponding to the original logical address. Accordingly, a processing time for copying data may be reduced when compared to the conventional method.

For a move command, operation of the storage system is as follows.

The host transmits, to the storage device, a move command for moving the target data indicated by the original logical address to the target logical address. The storage device processes the move command by updating the mapping table to enable the target logical address rather than the original logical address to indicate the target data.

Similar to the copy command, a method of updating the mapping table by the controller for processing the move command may be classified largely into two methods.

According to a first method, in response to the move command, the controller may update the mapping table to enable the target logical address rather than the original logical address to indicate the target data while maintaining the physical address of the storage space in which the target data is stored. In this case, similar to processing of the copy command, the move command may be only processed by modification of the mapping table without an operation of reading or transmitting the target data.

According to a second method, in response to the move command, the controller extracts the target data from a first storage space in which the target data is stored and stores the target data in a second storage space. Also, the controller invalidates the original logical address indicating the target data stored in the first storage space, and updates the mapping table to enable the target logical address to indicate the target data stored in the second storage space. In this instance, the controller may store the target data in the second storage space without returning the target data to the host.

That is, the process of processing the move command according to an exemplary embodiment of the present invention further includes an operation of invalidating the original logical address in addition to the process of processing the copy command.

A common feature of the two methods of processing the move command described in the foregoing is that the target data is not transmitted between the storage device and the host during processing the move command. That is, in an exemplary embodiment of the present invention, if the host notifies only the original logical address and the target logical address to the storage device, the storage device alone may move, to the target logical address, the target data corresponding to the original logical address. Accordingly, a processing time for moving data may be reduced when compared to the conventional method.

FIG. 3 is a diagram illustrating an example of processing a copy command in a storage device according to an exemplary embodiment of the present invention.

Referring to FIG. 3, for example, a logical address recognized by a host is in the range of 0 to 7. Also, a physical address of a storage space of a memory array of a storage device is in the range of 0 to 7. A mapping relationship between each logical address and each physical address is stored in a mapping table.

Data A is stored in a physical address 3, and a logical address 2 indicates the physical address 3. In this circumstance, when the host transmits, to the storage device, a copy command for copying the data A corresponding to the logical address 2, that is, an original logical address, to a logical address 5, that is, a target logical address, a controller of the storage device updates the mapping table to enable the logical address 5 to indicate the physical address 3. That is, the mapping table is updated to enable both the logical address 2 and the logical address 5 to indicate the physical address 3. Accordingly, processing of the copy command is completed.

In this case, the host may read the data A stored in the physical address 3 through a read command to the logical address 2, and may also read the data A stored in the physical address 3 through a read command to the logical address 5.

This method may process a copy command of data only by updating the mapping table without a data write operation, thereby reducing a processing time and improving data stability.

The process of processing the move command further includes an operation of invalidating the logical address 2 in addition to the process of processing the copy command described with reference to FIG. 3. That is, the mapping table may be modified to disenable the logical address 2, that is, the original logical address, to indicate the physical address 3. Accordingly, the physical address 3 may be only mapped to the logical address 5, that is, the target logical address.

FIG. 4 is a diagram illustrating another example of processing a copy command in a storage device according to an exemplary embodiment of the present invention.

Referring to FIG. 4, when a host transmits, to a storage device, a copy command for copying data A corresponding to a logical address 2, that is, an original logical address to a logical address 5, that is, a target logical address, the storage device may extract the data A stored in a storage space of a physical address 3, that is, a first storage space, corresponding to the logical address 2, and replicates and stores the extracted data A in a storage space of a physical address 4, that is, a second storage space. Also, the storage device may update a mapping table to enable the logical address 5, that is, the target logical address to indicate the physical address 4 in which the replicated data A is stored.

In this process, the data A of the physical address 3 may be transmitted from a memory array to a controller, and the data A may be transmitted from the controller to the physical address 4 of the memory array again. However, since transmission of the data A corresponds to data transmission performed inside the storage device, a read command and a write command, not a copy command, are used, and accordingly, a processing rate and data stability may be improved when compared to the conventional method involving data transmission between a host and a storage device.

The process of processing the move command further includes an operation of invalidating the logical address 2 in addition to the process of processing the copy command described with reference to FIG. 4. That is, the mapping table may be modified to disenable the logical address 2, that is, the original logical address to indicate the physical address 3. However, the data A stored in the physical address 3 may not be deleted. Accordingly, to write new data in the physical address 3, an operation of deleting the data A of the physical address 3 may be required.

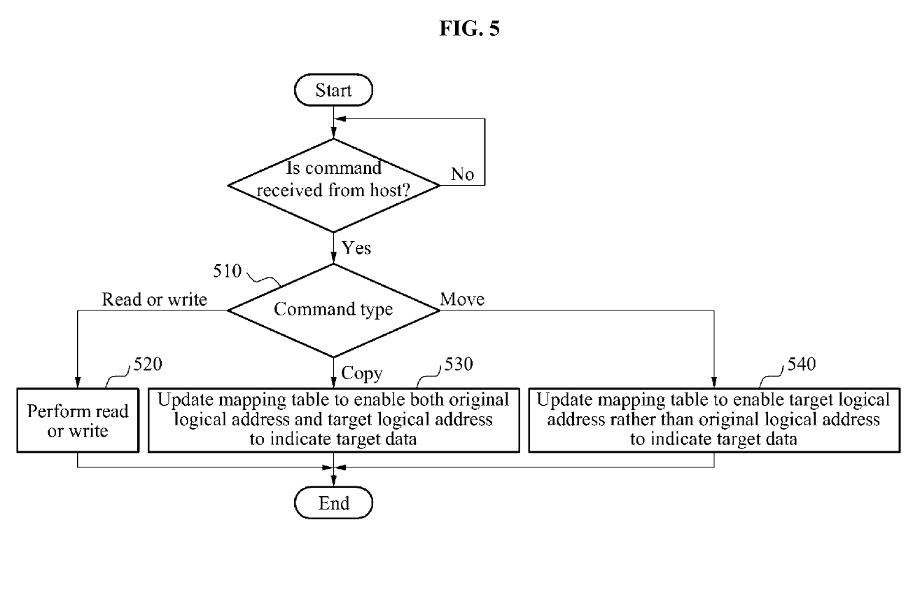

FIG. 5 is a flowchart illustrating an operation method of a storage device for processing a copy command and a move command according to an exemplary embodiment of the present invention.

Referring to FIG. 5, a storage device according to an exemplary embodiment of the present invention maintains a set of command including a write command, a read command, and a copy command.

In operation 510, when a command is received from a host, the storage device determines a type of the command.

In operation 520, when the command from the host corresponds to a read command or a write command, the storage device processes the read command or the write command in accordance with a conventional method.

In operation 530, when the command from the host corresponds to a copy command for copying target data indicated by an original logical address to a target logical address, the storage device processes the copy command by updating a mapping table between a logical address and a physical address to enable both the original logical address and the target logical address to indicate the target data.

In this instance, the storage device may update the mapping table to enable both the original logical address and the target logical address to indicate the target data while maintaining a physical address of a storage space in which the target data is stored.

Also, the storage device may extract the target data from a first storage space in which the target data is stored, may store the extracted target data in a second storage space, and may update the mapping table to enable the original logical address to indicate the target data stored in the first storage space and the target logical address to indicate the target data stored in the second storage space.

The storage device may store the target data in the second storage space without returning the extracted target data to the host during processing the copy command.

In operation 540, when the command from the host corresponds to a move command for moving the target data indicated by the original logical address to the target logical address, the storage device processes the move command by updating the mapping table between the logical address and the physical address to enable the target logical address rather than the original logical address to indicate the target data.

In this instance, the storage device may update the mapping table to enable the target logical address rather than the original logical address to indicate the target data while maintaining the physical address of the storage space in which the target data is stored.

Also, the storage device may extract the target data from the first storage space in which the target data is stored, may store the target data in the second storage space, invalidate the original logical address indicating the target stored in the first storage space, and may update the mapping table to enable the target logical address to indicate the target data stored in the second storage space.

Hereinabove, the method of operating the storage device according to the present invention is described. The disclosure provided through the exemplary embodiments of FIGS. 2 through 4 described in the foregoing may be applied to the method of operating the storage device, and thus a further detailed description is omitted herein.

The methods described above may be recorded, stored, or fixed in one or more non-transitory computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable media include magnetic media such as hard discs, floppy discs, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa. In addition, a non-transitory computer-readable storage medium may be distributed among computer systems connected through a network and non-transitory computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. An operation method of a storage device connected to a host, the operation method comprising:
maintaining a set of commands including a write command, a read command, and a copy command;
receiving, from the host, a copy command for copying a target data indicated by an original logical address to a target logical address; and
processing the copy command by updating a mapping table between a logical address and a physical address to enable both the original logical address and the target logical address to indicate the target data.

2. The operation method of claim 1, wherein the processing of the copy command comprises updating the mapping table to enable both the original logical address and the target logical address to indicate the target data while maintaining a physical address of a storage space in which the target data is stored.

3. The operation method of claim 1, wherein the processing of the copy command comprises:
extracting the target data from a first storage space in which the target data is stored;
storing the target data in a second storage space; and
updating the mapping table to enable the original logical address to indicate the target data stored in the first storage space and the target logical address to indicate the target data stored in the second storage space.

4. The operation method of claim 3, wherein the storing of the target data in the second storage space comprises storing the target data in the second storage space without returning the extracted target data to the host.

5. An operation method of a storage device connected to a host, the operation method comprising:
maintaining a set of commands including a write command, a read command, and a move command;
receiving, from the host, a move command for moving a target data indicated by an original logical address to a target logical address; and
processing the move command by updating a mapping table between a logical address and a physical address to enable the target logical address rather than the original logical address to indicate the target data.

6. The operation method of claim 5, wherein the processing of the move command comprises updating the mapping table to enable the target logical address rather than the original logical address to indicate the target data while maintaining a physical address of a storage space in which the target data is stored.

7. The operation method of claim 5, wherein the processing of the move command comprises:
extracting the target data from a first storage space in which the target data is stored;
storing the target data in a second storage space; and
invalidating the original logical address indicating the target data stored in the first storage space, and updating the mapping table to enable the target logical address to indicate the target data stored in the second storage space.

8. A storage device connected to a host, the storage device comprising:
a memory array including a plurality of storage spaces; and
a controller to process an arbitrary command among a set of commands including a write command, a read command, and a copy command,
wherein the controller processes a copy command by updating a mapping table between a logical address and a physical address to enable both an original logical address and a target logical address to indicate a target data, when the copy command for copying the target data indicated by the original logical address to the target logical address is received from the host.

9. The storage device of claim 8, wherein the controller updates the mapping table to enable both the original logical address and the target logical address to indicate the target data while maintaining a physical address of a storage space in which the target data is stored.

10. The storage device of claim 8, wherein the controller extracts the target data from a first storage space in which the target data is stored, stores the target data in a second storage space, and updates the mapping table to enable the original logical address to indicate the target data stored in the first storage space and the target logical address to indicate the target data stored in the second storage space.

11. The storage device of claim 8, wherein the set of commands further includes a move command, and
the controller processes the move command by updating the mapping table to enable the target logical address rather than the original logical address to indicate the target data, when the move command for moving the target data indicated by the original local address to the target logical address is received from the host.

12. The storage device of claim 11, wherein the controller updates the mapping table, in response to the move command, to enable the target logical address rather than the original logical address to indicate the target data while maintaining a physical address of a storage space in which the target data is stored.

13. The storage device of claim 11, wherein the controller extracts, in response to the move command, the target data from a first storage space in which the target data is stored, stores the target data in a second storage space, invalidates the original logical address indicating the target data stored in the first storage space, and updates the mapping table to enable the target logical address to indicate the target data stored in the second storage space.

14. A storage system comprising:
a host to transmit an arbitrary command among a set of commands including a write command, a read command, and a copy command; and
a storage device comprising:
a memory array including a plurality of storage spaces; and
a controller to process the arbitrary command received from the host,
wherein the controller processes a copy command by updating a mapping table between a logical address and a physical address to enable both an original logical address and a target logical address to indicate a target data, when the host transmits the copy command for copying the target data indicated by the original logical address to the target logical address.
